(19) United States
(12) Patent Application Publication
(10) Pub. No.: US 2010/0092366 A1
(43) Pub. Date: Apr. 15, 2010

(54) WATER-BASED POLISHING SLURRY FOR POLISHING SILICON CARBIDE SINGLE CRYSTAL SUBSTRATE, AND POLISHING METHOD FOR THE SAME

(75) Inventors: Hisao Kogoi, Chichibu-shi (JP); Naoki Oyanagi, Chichibu-shi (JP); Yasuyuki Sakaguchi, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/520,694

(22) PCT Filed: Dec. 17, 2007
(86) PCT No.: PCT/JP2007/074616

§ 371 Date: Sep. 1, 2009

(30) Foreign Application Priority Data
Dec. 27, 2006 (JP) 2006-351004

(51) Int. Cl. C09K 13/04; B24B 1/00; C01B 31/36; C09K 3/14

(52) U.S. Cl. 423/345; 451/41; 252/79.2

(57) ABSTRACT

A water-based polishing slurry for polishing a silicon carbide single crystal, wherein the slurry comprises abrasive particles having a mean particle size of 1 to 400 nm and an inorganic acid, and the slurry has a pH of less than 2 at 20° C.

### CROSS REFERENCE TO RELATED APPLICATIONS

This application is an application filed under 35 U.S.C. §111(a) claiming the benefit pursuant to 35 U.S.C. §119(e)(1) of the filing date of Japanese Patent Application No. 2006-351004 filed Dec. 27, 2006 pursuant to 35 U.S.C. §111(b).

### TECHNICAL FIELD

The present invention relates to a water-based polishing slurry for polishing silicon carbide single crystal substrates. In particular, the invention relates to a water-based polishing slurry with which silicon carbide single crystal substrates can be fine-polished so that the substrates have no scratches or damaged layers; and to silicon carbide single crystal substrates without damaged layers, which substrates are polished by using the slurry.

### BACKGROUND ART

A silicon carbide semiconductor has advantages such as a high dielectric breakdown voltage, a wide energy band gap, and a high heat conductivity. The semiconductor is thus usable for high power devices, high-temperature-resistant device materials, radiation-resistant device materials, high frequency device materials, or the like, and the semiconductor is expected to have better performances than silicon semiconductors. When silicon carbide is used as a device material, a silicon carbide single crystal is sliced into a wafer form; the wafer is polished to have an ultra-smooth mirror surface; silicon carbide is epitaxially grown on the surface; and a metal film or an oxide film is subsequently formed, thereby processing the wafer into devices.

Silicon carbide is extremely chemically stable and highly resistant to attack by acids or alkalis. Silicon carbide has also hardness second to diamond. For fine polishing a material with such properties, wet polishing is suitable and various methods have been tried so far.

Examples of the methods include: a polishing method in which a suspension obtained by suspending silica, alumina, or chromium oxide in a solution adjusted to be alkaline is used (JP-A HEI 07-288243); a polishing method in which diamond having a mean particle size of 0.05 to 0.6 μm is used, and subsequently a polishing slurry composed of colloidal silica is used (JP-A HEI 10-275758); a dry polishing method in which chromium oxide is used and the atmosphere is controlled to be high oxygen concentration (JP-A 2000-190206); a polishing method in which a solution obtained by agglomerating abrasive particles in the presence of hydrogen peroxide is used, and the agglomerated particles are dispersed moderately by using organosilane or silicone oil (JP-A 2001-326200); a polishing method in which a slurry containing an organic acid and colloidal silica is used (JP-A 2003-197574); a polishing method in which an alkaline polishing solution adjusted to have a pH of 7 to 10 and comprising 5 to 40 weight % of colloidal silica is used (JP-A 2004-299018); a polishing method in which an abrasive composition composed of a polishing agent consisting of chromium oxide, an oxidizing agent, at least one additive selected from the group consisting of aluminum nitrate, nickel nitrate, and cupric nitrate, and water is used (JP-A 2004-327952); a polishing method in which a composition having a pH of 4 to 9 and comprising colloidal silica is used (JP-A 2005-117027); and a polishing method in which chromium oxide powder is used as abrasive particles in the presence of hydrogen peroxide, or oxidizing powder such as manganese dioxide powder or manganese sesquioxide powder (JP-A 2001-205555).

Although the polishing slurries are designed by putting some thought into their liquid properties and the like, the slurries have drawbacks that insufficient chemical reactivity with silicon carbide requires long-time polishing, and use of the slurries causes a polishing flaw called a scratch or insufficient surface roughness. When a material having hardness equal to or higher than silicon carbide is used as abrasive particles, diamond is often used. The mechanism of such polishing is to scrape mechanically a surface to be polished, and there are drawbacks that use of abrasive particles causes micro scratches, the surface is not planarized sufficiently, and the polishing process causes a damaged layer on the polished surface (hereinafter, referred to as a damaged layer).

For removing a damaged layer on a silicon carbide single crystal substrate, a method in which the layer is removed by using an etching gas (JP-A 2006-261563) can be used. This method uses gas etching and requires sufficient control of equipment and long-time etching process to obtain a desired smooth surface.

Although there are methods in which temperature or pressure on polishing is controlled, the extremely high hardness and the lack of the chemical reactivity of silicon carbide restrict polishing methods and equipment. As a result, use of the methods does not always provide polished surfaces with sufficient properties such as surface flatness.

### DISCLOSURE OF THE INVENTION

An object of the present invention is to provide a polishing slurry with which fine polishing of silicon carbide single crystal substrates to be used for electronics applications achieves highly accurate surface polishing that provides high surface flatness and small surface roughness and not causing micro scratches, micro pits or a damaged layer on the surface and a high polishing speed is achieved as well.

The present inventors studied thoroughly to achieve the object and the present invention has been thus accomplished.

(1) A water-based polishing slurry for polishing a silicon carbide single crystal substrate, wherein the slurry comprises abrasive particles having a mean particle size of 1 to 400 nm and an inorganic acid, and the slurry has a pH of less than 2 at 20° C.

(2) The water-based polishing slurry according to (1), comprising 1 to 30 mass % of the abrasive particles.

(3) The water-based polishing slurry according to (1) or (2), wherein the abrasive particles are silica particles.

(4) The water-based polishing slurry according to any one of (1) to (3), wherein the inorganic acid is at least one acid among hydrochloric acid, nitric acid, phosphoric acid, and sulfuric acid.

(5) The water-based polishing slurry according to any one of (1) to (4), further comprising an anti-gelling agent.

(6) The water-based polishing slurry according to (5), comprising 1-hydroxyethylidene-1,1-diphosphonic acid as the anti-gelling agent.

(7) The water-based polishing slurry according to (5) or (6), comprising 0.01 to 6 mass % of the anti-gelling agent.

(8) The water-based polishing slurry according to any one of (1) to (7), further comprising 0.5 to 5 mass %, inclusive, of hydrogen peroxide as an oxidizing agent.

(9) A method of polishing a silicon carbide single crystal substrate, wherein a surface of the substrate is polished by using the water-based polishing slurry according to any one of (1) to (8).

(10) A method of polishing a silicon carbide single crystal substrate, wherein a damaged layer in a surface of the substrate is removed by polishing with the water-based polishing slurry according to any one of (1) to (8).

(11) A silicon carbide single crystal substrate obtained by the method of polishing a silicon carbide single crystal substrate according to (9) or (10).

By using the polishing slurry according to the present invention, surface flatness can be enhanced and scratches or damaged layers can be removed in the (0001) Si faces and the (000-1) C faces of silicon carbide (SiC) single crystal wafers so that the wafers can be used as substrates for electronics devices. Use of the slurry thus can remarkably enhance the quality of epitaxial layers, and the slurry is expected to highly contribute to the mass production of silicon carbide devices in terms of cost and quality.

### BRIEF DESCRIPTION OF THE DRAWINGS

FIG. 1 is a photograph taken on inspection for scratches with an AFM in a ⊚ case among Examples in Table 1;

FIG. 2 is a photograph taken on inspection for scratches with an AFM in a × case among Comparative Examples in Table 1; and

FIG. 3 is a photograph taken on inspection for damaged layers with an AFM in a ⊚-evaluated case among Examples.

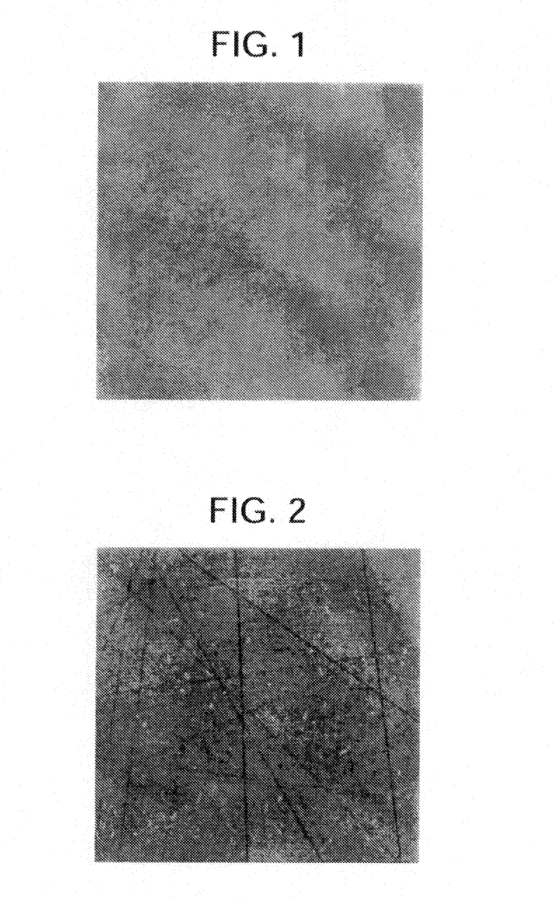

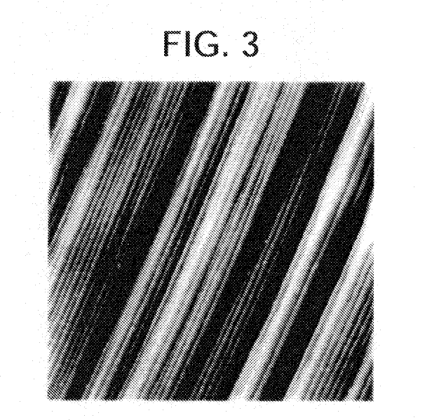

### BEST MODE FOR CARRYING OUT THE INVENTION

Silicon carbide wafers used for electronics devices are generally obtained through the following steps: (1) a step of sublimating silicon carbide powder and recrystallizing silicon carbide on seed crystals facing to each other to obtain a silicon carbide single crystal ingot; (2) a step of slicing the ingot; (3) a step of grinding thus obtained slice until the slice has a predetermined thickness; (4) a step of further polishing the slice until the slice has a mirror surface; (5) a step of forming a silicon carbide thin film on thus obtained substrate by epitaxial growth; and (6) a step of further forming a metal film or an oxide film to provide various devices.

The polishing step is described further in detail. The polishing step comprises a plurality of polishing steps such as rough polishing generally called lapping, fine polishing called polishing, and chemical-mechanical polishing (hereinafter, referred to as CMP), which is ultra-fine polishing. The polishing steps are often conducted by wet processes. The steps share that polishing is conducted by pressing a polishing head to which a silicon carbide substrate is bonded against a rotating platen to which a polishing pad is attached while a polishing slurry is fed. The polishing slurry according to the present invention is generally used in such steps, but the slurry can be used in any wet polishing using a polishing slurry.

Particles to be used as abrasive particles may be any particles that disperse and does not dissolve in the pH region of a polishing solution. Polishing solutions in the present invention have a pH of less than 2, and usable materials for abrasive particles include diamond, silicon carbide, aluminum oxide, titanium oxide, and silicon oxide. Usable abrasive particles in the present invention have a mean particle size of 1 to 400 nm, desirably 10 to 200 nm, and more desirably 10 to 150 nm. To obtain a good finish surface, silica is preferable because silica having small particle size is commercially available at low cost; and colloidal silica is more preferable. The particle size of a polishing agent such as colloidal silica may be properly selected depending on processing properties such as processing rate or surface roughness. When higher polishing rate is required, a polishing agent having large particle size can be used. When small surface roughness, that is, a highly flat surface is required, a polishing agent having small particle size can be used. Use of a polishing agent having a mean particle size of greater than 400 nm does not achieve high polishing rate for its high cost, and such agents are not cost effective. Use of a polishing agent having an extremely small particle size such as a size of less than 1 nm results in a significantly decreased polishing rate.

The mean particle size can be a conversion size based on specific surface area (BET method). The mean particle size can also be determined by using a laser-Doppler particle size distribution analyzer, or the like. The mean particle size mentioned above is determined by the laser-Doppler particle size distribution analyzer. By using the laser-Doppler particle size distribution analyzer, the sizes of particles, in most cases, the sizes of secondary particles in a slurry are determined. The particle size distribution of abrasive particles can be selected properly depending on a purpose. Abrasive particles having particle size distribution as wide as possible are excellent in view of polishing rate, surface roughness, waviness, or the like, but it is preferred that abrasive particles do not contain excessively large size particles for the mean particle size of the abrasive particles.

The amount of the abrasive particles to be added is 1 to 30 mass %, and desirably 1.5 to 15 mass %. When the amount is greater than 30 mass %, the drying rate of abrasive particles is high, and which highly possibly causes scratches. Such an amount is also not cost effective. The amount of the abrasive particles less than 1 mass % is not preferable because processing rate is too low.

The polishing slurry according to the present invention is a water-based polishing slurry and has a pH of less than 2.0 at 20° C., desirably less than 1.5, and more desirably less than 1.2. Sufficient polishing rate is not achieved in the pH region of equal to or more than 2.0. In contrast, by adjusting the slurry to have a pH of less than 2, the slurry exhibits considerably enhanced chemical reactivity to silicon carbide even in a normal indoor environment, and ultra-fine polishing can be conducted. The mechanism of the polishing is understood that silicon carbide is not removed directly by the mechanical action of oxide particles in a polishing slurry; but the surface of a silicon carbide single crystal is turned into silicon oxide by chemical reaction caused by a polishing solution and the silicon oxide is removed mechanically by abrasive particles. To obtain smooth surfaces without scratches or damage layers, what is extremely important is therefore to adjust the composition of a polishing solution to have liquid properties more likely to react with silicon carbide, that is, to adjust the solution to have a pH of less than 2 and to select oxide particles having proper hardness as abrasive particles.

The polishing slurry is adjusted to have a pH of less than 2 by using at least one acid, preferably two or more acids, among hydrochloric acid, nitric acid, phosphoric acid, and sulfuric acid. The mechanism that use of a plurality of acids provides advantageous effect is not known, but the effect is experimentally verified. There is a possibility that acids interact with each other to enhance their effect. As for the amounts of the acids to be added, for example, type and amount are properly selected within the following ranges and the polishing slurry is adjusted to have a pH of less than 2: 0.5 to 5 mass % of sulfuric acid, 0.5 to 5 mass % of phosphoric acid, 0.5 to 5 mass % of nitric acid, and 0.5 to 5 mass % of hydrochloric acid.

Inorganic acids are preferable because they have stronger acidity than organic acids and use of inorganic acids is extremely convenient for adjusting a polishing solution to have a predetermined strong acidity. Use of organic acids involves difficulties in adjusting a polishing solution to have a strong acidity.

Silicon carbide is polished by forming an oxide film on the surface of silicon carbide by the reactivity of a strongly acidic polishing solution to silicon carbide and by removing the oxide layer by using oxide particles. To accelerate the oxidation of the surface, addition of an oxidizing agent to the polishing slurry provides further advantageous effect. Examples of the oxidizing agent may include hydrogen peroxide, perchloric acid, potassium dichromate, and ammonium persulfate. For example, the addition of 0.5 to 5 mass %, desirably 1.5 to 4 mass %, of hydrogen peroxide increases a polishing rate. The oxidizing agent is not restricted to hydrogen peroxide.

The polishing slurry may comprise an anti-gelling agent for the purpose of inhibiting gelling of abrasive material. Preferred anti-gelling agents are phosphate-based chelating agents such as 1-hydroxyethylidene-1,1-diphosphonic acid or amino triethylene phosphonic acid. The anti-gelling agent is preferably added in the range of 0.01 to 6 mass %, and preferably 0.05 to 2 mass %.

Silicon carbide substrates polished using the polishing slurry do not have damaged layers caused by polishing processes. To process the silicon carbide substrates into devices, an epitaxial growth step is required. In the step, a silicon carbide substrate is firstly etched by using a hydrogen gas. When the substrate has a damaged layer, the etching reveals flaws such as scratches for the first time. The damage layer is inspected by observing the hydrogen-etched surface of a silicon carbide substrate, for example, by using an atomic force microscope (AFM). When the surface has no damage layer, observed are only the atomic steps of silicon carbide, that is, streaks heading to the same direction. In contrast, when the surface has a damage layer, observed are streak-like trajectories heading to random directions.

The damaged layers cause crystal defects in epitaxial layers, and considerably degrade the properties of substrates. It is thus extremely important to set polishing conditions under which no damage layer is generated in polishing processes. Use of the polishing slurry according to the present invention can provide silicon carbide substrates without damaged layers. Use of the polishing slurry according to the present invention can also polish and remove damaged layers present prior to the polishing process of the present invention.

Hereinafter, the present invention is described further in detail with referring to Examples, but the invention is not restricted to the Examples.

### Examples 1 to 17 and Comparative Examples 1 to 7

Polishing slurries were prepared by preparing solutions having compositions shown in Table 1, and adding commercially available colloidal silica (Levasil 50 manufactured by Bayer) to water so that the amounts of the colloidal silica were 10.0 mass % (Examples) and each value in Table 1 (Comparative Examples). After that, the (0001) Si faces of 2-inch-diameter 4H silicon carbide single crystal wafers were polished under the following conditions.

### Polishing Conditions

Polishing test machine: single-sided polishing machine SPM-11 manufactured by Fujikoshi Machinery Corp.

Polishing pad: suede type (2900W manufactured by TORAY COATEX CO., LTD.)

Slurry feeding rate: 40 ml/minute

Platen rotational frequency: 60 rpm

Processing pressure: 350 g/cm²

Polishing time: 60 minutes

Polished wafers were evaluated by observing scratches with an AFM (atomic force microscope NanoScope IIIa manufactured by Japan Veeco Co., Ltd.), measuring surface roughness also by using an AFM, and visually inspecting the wafers under focused lamp of halogen light in a darkroom. Note that measurement points by observation with the AFM were three points at intervals of 2 cm in the [11-20] direction and three points at intervals of 2 cm in the [10-10] direction orthogonal with the [11-20] direction. The average value among the points was shown as an evaluation result.

Evaluation of damaged layers was conducted by hydrogen-etching the polished silicon carbide substrates at 1550° C. at 200 millibar for 10 minutes, and subsequently observing the surfaces of the substrates with the AFM.

In the table, as to evaluation of AFM scratch, ⊚ denotes no flaws (scratches) in the field of view, ◯ denotes no scratches but some shallow slight scratch-like streaks, and × denotes the presence of scratches. As for evaluation of visual inspection with focused lamp and damaged layer, ⊚ denotes qualitatively good, × denotes poor, ◯ denotes rather good, and Δ denotes rather poor.

TABLE 1

| | Water-based polishing slurry | | | | | | | | | Evaluation | | | | |
|---|---|---|---|---|---|---|---|---|---|---|---|---|---|---|
| | Abrasive particles | | Composition of polishing solution | | | | | | | | | Surface | Visual | |
| | | Addi- | | Addi- | | | | | | | | rough- | inspection | |
| | | tional | | tional | Oxi- | Additional | Anti- | Additional | Pure | | | ness | with | Dam- |
| Exam- | | amount | | amount | dizing | amount | gelling | amount | water | | AFM | Ra | focused | aged |
| ples | Type | mass % | Acid | mass % | agent | mass % | agent | % | mass % | pH | scratch | nm | lamp | layer |
| Ex. 1 | Colloidal silica | 10.0 | H₂SO₄ | 1.8 | H₂O₂ | 2.3 | HEDP | 1.8 | 84.1 | 1.5 | ⊚ | 0.03 | ⊚ | ◯ |
| Ex. 2 | Colloidal silica | 10.0 | H₂SO₄ | 7.2 | H₂O₂ | 2.3 | HEDP | 0.1 | 80.4 | 0.7 | ◯ | 0.06 | ⊚ | ⊚ |
| Ex. 3 | Colloidal silica | 10.0 | H₂SO₄ | 7.2 | H₂O₂ | 2.3 | HEDP | 0.5 | 80.0 | 0.7 | ⊚ | 0.04 | ⊚ | ⊚ |
| Ex. 4 | Colloidal silica | 10.0 | H₂SO₄ | 5.4 | H₂O₂ | 2.3 | HEDP | 1.8 | 80.5 | 1.0 | ⊚ | 0.06 | ⊚ | ⊚ |
| Ex. 5 | Colloidal silica | 10.0 | H₂SO₄ | 3.6 | H₂O₂ | 2.3 | HEDP | 3.6 | 80.5 | 1.0 | ⊚ | 0.06 | ⊚ | ⊚ |
| Ex. 6 | Colloidal silica | 10.0 | HNO₃ | 1.8 | H₂O₂ | 2.3 | HEDP | 1.8 | 84.1 | 1.2 | ⊚ | 0.03 | ⊚ | ◯ |
| Ex. 7 | Colloidal silica | 10.0 | HNO₃ | 7.2 | H₂O₂ | 2.3 | HEDP | 0.1 | 80.4 | 0.8 | ◯ | 0.06 | ⊚ | ⊚ |
| Ex. 8 | Colloidal silica | 10.0 | HNO₃ | 7.2 | H₂O₂ | 2.3 | HEDP | 0.5 | 80.0 | 0.3 | ◯ | 0.05 | ⊚ | ⊚ |
| Ex. 9 | Colloidal silica | 10.0 | HNO₃ | 5.4 | H₂O₂ | 2.3 | HEDP | 1.8 | 80.5 | 0.2 | ⊚ | 0.04 | ⊚ | ⊚ |
| Ex. 10 | Colloidal silica | 10.0 | HNO₃ | 3.6 | H₂O₂ | 2.3 | HEDP | 3.6 | 80.5 | 0.3 | ⊚ | 0.03 | ⊚ | ⊚ |
| Ex. 11 | Colloidal silica | 10.0 | HNO₃ | 3.6 | H₂O₂ | 0.5 | HEDP | 3.6 | 82.3 | 0.3 | ⊚ | 0.03 | ⊚ | ⊚ |
| Ex. 12 | Colloidal silica | 10.0 | HNO₃ | 3.6 | H₂O₂ | 4.5 | HEDP | 3.6 | 78.3 | 0.5 | ⊚ | 0.05 | ⊚ | ⊚ |
| Ex. 13 | Colloidal silica | 10.0 | H₃PO₄ | 1.8 | H₂O₂ | 2.3 | HEDP | 1.8 | 84.1 | 0.7 | ◯ | 0.06 | ⊚ | ⊚ |
| Ex. 14 | Colloidal silica | 10.0 | H₃PO₄ | 7.2 | H₂O₂ | 2.3 | HEDP | 0.1 | 80.4 | 0.9 | ◯ | 0.05 | ⊚ | ⊚ |
| Ex. 15 | Colloidal silica | 10.0 | H₃PO₄ | 7.2 | H₂O₂ | 2.3 | HEDP | 0.5 | 80.0 | 0.9 | ◯ | 0.07 | ⊚ | ⊚ |
| Ex. 16 | Colloidal silica | 10.0 | H₃PO₄ | 5.4 | H₂O₂ | 2.3 | HEDP | 1.8 | 80.5 | 1.0 | ⊚ | 0.03 | ⊚ | ⊚ |
| Ex. 17 | Colloidal silica | 10.0 | H₃PO₄ | 3.6 | H₂O₂ | 2.3 | HEDP | 3.6 | 80.5 | 0.8 | ⊚ | 0.03 | ⊚ | ⊚ |

| | |
|---|---|
| Abrasive particles | Evaluation |

| | | Additional | pH | | | Surface | | |
|---|---|---|---|---|---|---|---|---|
| Comparative | | amount | adjustor | | AFM | roughness Ra | Visual inspection | Damaged |
| Examples | Type | mass % | Acid | pH | scratch | nm | with focused lamp | layer |
| Com. Ex. 1 | Colloidal silica | 10 | H₂SO₄ | 2.4 | X | 0.08 | Δ | X |
| Com. Ex. 2 | Colloidal silica | 8 | H₂SO₄ | 4.0 | X | 0.09 | Δ | X |
| Com. Ex. 3 | Colloidal silica | 10 | HNO₃ | 3.1 | X | 0.09 | Δ | X |
| Com. Ex. 4 | Colloidal silica | 8 | HNO₃ | 5.3 | X | 0.12 | Δ | X |
| Com. Ex. 5 | 50 nm diamond | 3 | HNO₃ | 4.0 | X | 0.16 | X | X |
| Com. Ex. 6 | 75 nm diamond | 3 | HNO₃ | 3.5 | X | 0.21 | X | X |
| Com. Ex. 7 | 50 nm alumina | 8 | HNO₃ | 2.3 | X | 0.08 | Δ | X |

All the colloidal silicas are Levasil 50 manufactured by Bayer

### INDUSTRIAL APPLICABILITY

By using the polishing slurry according to the present invention, the surface flatness of substrates can be enhanced and scratches or damaged layers can be removed so that the substrates can be used as substrates for electronics devices. Use of the slurry can remarkably enhance the quality of epitaxial layers, and the slurry is expected to highly contribute to the mass production of silicon carbide devices in terms of cost and quality.

The substrates are usable for high power devices, high-temperature-resistant device materials, radiation-resistant device materials, high frequency device materials, or the like.

1. A water-based polishing slurry for polishing a silicon carbide single crystal substrate, wherein the slurry comprises abrasive particles having a mean particle size of 1 to 400 nm and an inorganic acid, and the slurry has a pH of less than 2 at 20° C.

2. The water-based polishing slurry according to claim 1, comprising 1 to 30 mass % of the abrasive particles.

3. The water-based polishing slurry according to claim 1, wherein the abrasive particles are silica particles.

4. The water-based polishing slurry according to claim 1, wherein the inorganic acid is at least one acid among hydrochloric acid, nitric acid, phosphoric acid, and sulfuric acid.

5. The water-based polishing slurry according to claim 1, further comprising an anti-gelling agent.

6. The water-based polishing slurry according to claim 5, comprising 1-hydroxyethylidene-1,1-diphosphonic acid as the anti-gelling agent.

7. The water-based polishing slurry according to claim 5, comprising 0.01 to 6 mass % of the anti-gelling agent.

8. The water-based polishing slurry according to claim 1, further comprising 0.5 to 5 mass %, inclusive, of hydrogen peroxide as an oxidizing agent.

9. A method of polishing a silicon carbide single crystal substrate, wherein a surface of the substrate is polished by using the water-based polishing slurry according to claim 1.

10. A method of polishing a silicon carbide single crystal substrate, wherein a damaged layer in a surface of the substrate is removed by polishing with the water-based polishing slurry according to claim 1.

11. A silicon carbide single crystal substrate obtained by the method of polishing a silicon carbide single crystal substrate according to claim 9.
